(19) United States
(12) Patent Application Publication
(10) Pub. No.: US 2015/0091218 A1
(43) Pub. Date: Apr. 2, 2015

(54) Apparatus and Method for Making an Article

(71) Applicant: Saint-Gobain Performance Plastics Corporation, Aurora, OH (US)

(72) Inventors: Boris L. Serebrennikov, Shrewsbury, MA (US); Aijun Zhu, Acton, MA (US); Aziz Mahfoud-Familia, Shrewsbury, MA (US)

(21) Appl. No.: 14/498,346

(22) Filed: Sep. 26, 2014

Related U.S. Application Data
(60) Provisional application No. 61/883,400, filed on Sep. 27, 2013.

(51) Int. Cl. B29C 45/16; B29C 45/73

(52) U.S. Cl. CPC B29C 45/1657; B29C 45/16; B29C 45/73; B29K 2083/005
USPC 264/478; 425/501; 425/174.4

(57) ABSTRACT

An apparatus for forming an injection molded article is disclosed. The apparatus includes a pumping system to deliver a silicone formulation to a mold, the silicone formulation having a viscosity of about 50,000 centipoise to about 2,000,000 centipoise. The mold has an exterior housing and an interior cavity therein, wherein the silicone formulation flows into the cavity of the mold. The apparatus further includes a source of radiation energy, wherein the radiation energy substantially cures the silicone formulation within the cavity of the mold to form the injection molded article. The present disclosure further includes a method of forming the injection molded article and a mold for an injection molded article.

### CROSS-REFERENCE TO RELATED APPLICATION

This application claims priority under 35 U.S.C. §119(e) to U.S. Patent Application No. 61/883,400 entitled “Apparatus and Method for Making an Article,” by Serebrennikov et al., filed Sep. 27, 2013, which is assigned to the current assignee hereof and incorporated herein by reference in its entirety.

### FIELD OF THE DISCLOSURE

The disclosure, generally, is related to an apparatus and method for forming an article, and more particularly, an injection molded article.

### BACKGROUND

Many industries utilize heat curing for silicone articles that are produced by injection molding processes. The silicone articles are typically formed by heat curing silicone formulations at an elevated temperature. For instance, temperatures in excess of at least 140° C. are used for the heat cure. For particular multiple component injection molded articles, the temperatures used for thermal cure of the silicone formulation often exceed the melting temperature of many desirable substrates.

Accordingly, silicone formulations have typically been commercially injection molded with high melt temperature substrates for multiple component injection molded articles. These multiple component injection molded articles are typically expensive since they are limited to high melt temperature substrates. Low melt temperature substrates would be desirable since they are often more cost effective; however, there has been considerable difficulty with injection molding silicone formulations with low melt temperature substrates. Unfortunately, the heat required for thermal cure of the silicone formulation prevents the use of many thermoplastic and thermoset materials that would degrade and deform at such temperatures. Furthermore, adhesion between dissimilar materials such as silicone formulations and thermoplastic or thermoset materials can be problematic, such that adhesion promoters, primers, chemical surface treatments, or even mechanical treatments must be used to provide the adhesion required for specific applications.

Accordingly, an improved method and apparatus to form an injection molded article are desired.

### SUMMARY

In an embodiment, an apparatus for forming an injection molded article is disclosed. The apparatus includes a pumping system to deliver a silicone formulation to a mold, the silicone formulation having a viscosity of about 50,000 centipoise to about 2,000,000 centipoise. The mold has an exterior housing and an interior cavity therein, wherein the silicone formulation flows into the cavity of the mold. The apparatus further includes a source of radiation energy, wherein the radiation energy substantially cures the silicone formulation within the cavity of the mold to form the injection molded article.

In another embodiment, a method of forming an injection molded article is provided. The method includes providing a silicone formulation within a pumping system, wherein the silicone formulation has a viscosity of about 50,000 centipoise to about 2,000,000 centipoise. The method further includes providing a mold having an exterior housing and an interior cavity therein, delivering the silicone formulation from the pumping system to the cavity of the mold; and irradiating the silicone formulation with a radiation source to substantially cure the silicone formulation within the cavity of the mold to form the injection molded article.

In yet another embodiment, a mold for an injection molded article is provided. The mold includes an exterior housing and an interior cavity therein, wherein the interior cavity is configured for receipt of a silicone formulation having a viscosity of about 50,000 centipoise to about 2,000,000 centipoise; and a source of radiation energy, wherein the radiation energy substantially cures the silicone formulation within the cavity of the mold to form the injection molded article.

### BRIEF DESCRIPTION OF THE DRAWINGS

The present disclosure may be better understood, and its numerous features and advantages made apparent to those skilled in the art by referencing the accompanying drawings.

FIG. 1 is a diagram of an embodiment of an apparatus to make an injection molded article.

FIG. 2 is a flow diagram of a process to make an injection molded article according to an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are open-ended terms and should be interpreted to mean “including, but not limited to . . . . ” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 25° C. For instance, values for viscosity are at 25° C., unless indicated otherwise.

The disclosure generally relates to an apparatus for forming an article, such as an injection molded article. The apparatus includes a pumping system to deliver at least one polymer material to a mold. The mold has an exterior housing and an interior cavity therein, wherein the at least one polymer material flows into the cavity of the mold. The apparatus further includes a source of radiation energy, wherein the radiation energy substantially cures the at least one polymer material within the cavity of the mold. In an embodiment, the apparatus is configured to provide any number of polymer materials to the mold to provide a multiple component injection molded article. In an embodiment, the at least one polymer material includes a first polymer material and a second polymer material that are different. In another embodiment, the at least one polymer material includes a first polymer material and a second polymer material that are the same. In an embodiment, the first polymer material is a thermoplastic polymer or a thermoset polymer. In a particular embodiment, the second polymer material includes a silicone formulation. In an example, the apparatus is configured so that an adhesive strength between the first polymer material and the second polymer material is improved within the interior cavity of the mold. Further, the apparatus is configured so that it may cure the second polymer material within the interior cavity of the mold. An improved method of forming an injection molded article is further provided.

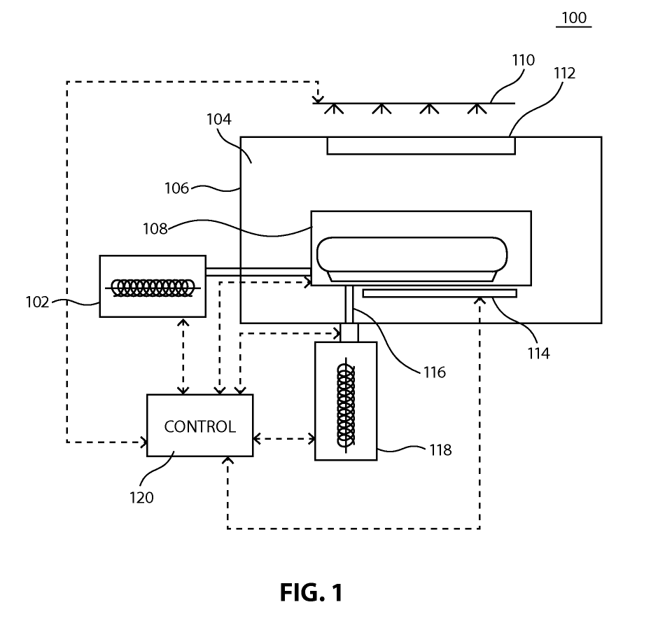

FIG. 1 is a diagram of an embodiment of an apparatus 100 to make an injection molded article. In a particular embodiment, the apparatus 100 includes a first pumping system 102. Any pumping system 102 is envisioned. The pumping system 102 may include any reasonable means to deliver a first polymer material such as pneumatically, hydraulically, gravitationally, mechanically, and the like, or combinations thereof. In an embodiment, the pumping system 102 delivers the first polymer material to a mold 104. The mold 104 includes an exterior housing 106 and an interior cavity 108 therein. The interior cavity 108 may be configured in any shape desired for the final injection molded article (not shown). In a particular embodiment, the first polymer material flows into the interior cavity 108 of the mold 104.

In an embodiment, the first polymer material may be any thermoplastic polymer or thermoset polymer envisioned. In a particular embodiment, the first polymer material is a polycarbonate, a polystyrene, an acrylonitrile butadiene styrene, a polyester, a copolyester (coPETS), a silicone polymer, a fluoropolymer, polyethylene, polypropylene, any other commodity thermoplastic resin, an engineering thermoplastic resin, or any combination thereof. The thermoplastic polymer or thermoset polymer may be formed with any reasonable component such as any precursors with the addition of any catalyst, any filler, any additives, or combination thereof. Any reasonable catalyst that can initiate crosslinking of the first polymer is envisioned. In an embodiment, the additive includes any reasonable adhesion promoter. Any reasonable adhesion promoter is envisioned and is dependent upon the first polymer. In an embodiment, the adhesion promoter is used with a silicone polymer, wherein the adhesion promoter is a silane, such as 3-methacryloxypropyltrimethoxysilane, 3-glycidoxypropyltrimethoxysilane, vinyl-tris(2-methoxyethoxy)-silane; 2,5,7,10-tetraoxa-6-silaundecane, 6-ethenyl-6-(2-methoxyethoxy)-silane, or any combination thereof. In a particular embodiment, the precursor, the catalyst, the filler, the additive, or combination thereof are dependent upon the first polymer chosen and final properties desired for the injection molded article.

The apparatus 100 further includes a source of radiation energy 110. In an embodiment, the source of radiation energy 110 is provided to the interior cavity 108 of the housing 106. The source of radiation energy 110 may be in any reasonable configuration to deliver the radiation energy to the interior cavity 108 of the housing 106. For instance, the source of radiation energy 110 can be delivered to any portion of the interior cavity 108, such as one side of the cavity 108, on opposing sides of the cavity 108, on adjacent sides of the cavity 108, or even circumferentially to the cavity 108. Delivery may further include direct radiation energy, radiation energy through fiber optic cables, or any combination thereof. As illustrated, the source of radiation energy 110 is external to the housing 106 of the mold 104. Although not illustrated, the source of radiation energy 110 may be contained within the housing 106. For instance, the source of radiation energy 110 may be disposed between the exterior housing 106 and the interior cavity 108.

In an embodiment, the radiation energy is configured to provide improved properties to the at least one polymer material depending upon the at least one polymer material and the final result desired. For instance, the radiation energy is configured to at least provide a surface treatment to the at least one polymer material. In an embodiment, the radiation energy substantially cures the material within the cavity of the mold 104, i.e. in situ, to form the injection molded article. The source of radiation energy 110 can include any reasonable radiation energy source such as actinic radiation. In a particular embodiment, the radiation source is ultraviolet light. Any reasonable wavelength of ultraviolet light is envisioned. In a specific embodiment, the ultraviolet light is at a wavelength of about 10 nanometers to about 410 nanometers. Further, any number of applications of radiation energy may be applied with the same or different wavelengths, depending upon the material and the desired result.

In a particular embodiment, the radiation source is sufficient to substantially treat the surface of the at least one polymer material. For instance, the radiation source is sufficient to substantially treat the surface of the first polymer material to increase the adhesion of the first polymer material, such as the thermoplastic material or the thermoset material, to the polymer material it directly contacts, for instance, the second polymer material. In an exemplary embodiment, the surface treatment increases the adhesion of the first polymer material to the second polymer material. In an embodiment, the surface treatment enables adhesion between the two materials to provide cohesive bonding, i.e. cohesive failure occurs wherein the structural integrity of the first polymer material and/or the second polymer material fails before the bond between the two materials fails. In an embodiment, the radiation source is sufficient to substantially cure at least one polymer material, such as the second polymer material. “Substantially cure” as used herein refers to >90% of final crosslinking density, as determined for instance by rheometer data (90% cure means the material reaches 90% of the maximum torque as measured by ASTM D5289). For instance, the level of cure is to provide an injection molded article having a desirable durometer. In an embodiment, the final durometer of the second polymer material depends on the material chosen for the second polymer.

In an embodiment, at least a portion 112 of the interior cavity 108 is substantially transparent to the radiation source 110. The portion 112 of the interior cavity 108 is substantially transparent to provide the transmission of the radiation source 110 into the interior cavity 108 of the apparatus 100 and to the first polymer material, the second polymer material, or combination thereof contained within the interior cavity 108. “Substantial transparency” as used herein refers to a material wherein about 1% to about 100%, such as at least about 25%, or even at least about 50% of the radiation source, such as ultraviolet light at about 10 nanometers to about 410 nanometers, can radiate through the portion 112 of the housing 106 to provide radiation to the first polymer material, the second polymer material, or combination thereof within the interior cavity 108. In a more particular embodiment, the transmission is greater than about 50% at about 300 nanometers. For instance, the portion 112 of the interior cavity 108 that is substantially transparent to the radiation source 110 may include a window. In an embodiment, the window is a quartz, a glass, a polymer, or combination thereof. The polymer for the window may be, for example, polymethyl methacrylate (PMMA), polystyrene, or combination thereof. Transparency typically is dependent upon the wavelength of the radiation source, the material, and the thickness of the material. For instance, PMMA has about 80% transmission at about 300 nm at 3 mm thickness. For quartz, the transmission may be greater than about 90% from about 200 nm to about 500 nm for a 10 mm thickness.

The apparatus 100 may further include a source of heat 114 for thermal treatment of the first polymer material, the second polymer material, or combination thereof within the cavity of the mold. Any source of thermal treatment is envisioned. In an embodiment, the source of thermal treatment includes, for example, an electric resistive heating element, an externally heated thermal fluid pumped through at least one channel in the mold, or combination thereof. Any temperature for thermal treatment is envisioned. In an embodiment, the thermal treatment is at a temperature not greater than the glass transition temperature or heat deflection temperature (HDT) of the first polymer material. In an embodiment, thermal treatment occurs at a low temperature. “Low temperature” is defined herein as the temperature below the heat deflection (HDT) of the first polymer material and is dependent upon the material. Exemplary thermal treatment includes temperatures, for instance, of greater than about 20° C., such as greater than about 100° C., or even greater than about 150° C. In a particular embodiment, the temperature is about 20° C. to about 200° C., such as about 20° C. to about 150° C., such as about 20° C. to about 100° C., or even about 40° C. to about 80° C. In an embodiment, the source of radiation and the thermal treatment may occur concurrently, in sequence, or any combination thereof. In a particular embodiment, the source of radiation and thermal treatment occurs concurrently. In a particular embodiment, the application of the radiation energy and the thermal treatment provides an increased adhesive bond between the first polymer material and the second polymer material. In a more particular embodiment, a cohesive bond is achieved between the first polymer material and the second polymer material, i.e. cohesive failure occurs wherein the structural integrity of the first polymer material and/or the second polymer material fails before the bond between the two materials fails.

In a particular embodiment, the application of the radiation energy and the thermal treatment provide a cure time that is 20% faster compared to a cure with a single source of energy. In a more particular embodiment, the application of the radiation energy and the thermal treatment provide a cure time for the second polymer material, such as the silicone formulation, that is 20% faster compared to a cure with a single source of energy.

In an embodiment, the apparatus 100 includes a port 116 to the cavity 108, the port 116 configured for connection to a second pumping system 118 to provide the second polymer material to the cavity 108. Any pumping system 118 is envisioned. The pumping system 118 may include any reasonable means to deliver the second polymer material such as pneumatically, hydraulically, gravitationally, mechanically, and the like, or combinations thereof.

In an embodiment, the second polymer material includes a silicone formulation. Prior to flowing to the inner cavity 108 and prior to cure, the silicone formulation has a viscosity of about 50,000 centipoise (cPs) to about 2,000,000 cPs, such as about 200,000 cPs to about 1,000,000 cPs, such as about 500,000 cPs to about 800,000 cPs. In an embodiment, the low viscosity silicone formulation is a liquid silicone rubber (LSR) or a liquid injection molding silicone (LIM), a room temperature vulcanizing silicone (RTV), or a combination thereof. In a particular embodiment, the low viscosity silicone formulation is a liquid silicone rubber or a room temperature vulcanizing silicone.

The silicone formulation may, for example, include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polyalkylsiloxane, such as a silicone hydride-containing polydimethylsiloxane. In a further embodiment, the polyalkylsiloxane is a vinyl-containing polyalkylsiloxane, such as a vinyl-containing polydimethylsiloxane. In yet another embodiment, the silicone polymer is a combination of a hydride-containing polyalkylsiloxane and a vinyl-containing polyalkylsiloxane, such as a combination of hydride-containing polydimethylsiloxane and a vinyl-containing polydimethylsiloxane. In an example, the silicone polymer is non-polar and is free of halide functional groups, such as chlorine and fluorine, and of phenyl functional groups. Alternatively, the silicone polymer may include halide functional groups or phenyl functional groups. For example, the silicone polymer may include fluorosilicone or phenylsilicone.

The silicone formulation may further include a catalyst. Typically, the catalyst is present to initiate the crosslinking process. Any reasonable catalyst that can initiate crosslinking when exposed to a radiation source is envisioned. Typically, the catalyst is dependent upon the silicone formulation. In a particular embodiment, the catalytic reaction includes aliphatically unsaturated groups reacted with Si-bonded hydrogen in order to convert the addition-crosslinkable silicone formulation into the elastomeric state by formation of a network. The catalyst is activated by the radiation source and initiates the crosslinking process.

Any catalyst is envisioned depending upon the silicone formulation, with the proviso that at least one catalyst can initiate crosslinking when exposed to the radiation source, such as ultraviolet radiation. In an embodiment, a hydrosilylation reaction catalyst may be used. For instance, an exemplary hydrosilylation catalyst is an organometallic complex compound of a transition metal. In an embodiment, the catalyst includes platinum, rhodium, ruthenium, the like, or combinations thereof. In a particular embodiment, the catalyst includes platinum. Further optional catalysts may be used with the hydrosilylation catalyst. Exemplary optional catalysts may include peroxide, tin, or combinations thereof. Alternatively, the silicone formulation further includes a peroxide catalyzed silicone formulation. In another example, the silicone formulation may be a combination of a platinum catalyzed and peroxide catalyzed silicone formulation.

The silicone formulation may further include an additive. Any reasonable additive is envisioned. Exemplary additives may include, individually or in combination, a vinyl polymer, a hydride, an adhesion promoter, a filler, an initiator, an inhibitor, a colorant, a pigment, a carrier material, or any combination thereof. For instance, the additive may include an adhesion promoter such as a silane, such as 3-methacryloxypropyltrimethoxysilane, 3-glycidoxypropyltrimethoxysilane, vinyl-tris(2-methoxyethoxy)-silane; 2,5,7,10-tetraoxa-6-silaundecane, 6-ethenyl-6-(2-methoxyethoxy)-silane, or any combination thereof. In an embodiment, the material content of the silicone article is essentially 100% silicone formulation. In some embodiments, the silicone formulation consists essentially of the respective silicone polymer described above. As used herein, the phrase “consists essentially of” used in connection with the silicone formulation precludes the presence of non-silicone polymers that affect the basic and novel characteristics of the silicone formulation, although, commonly used processing agents and additives may be used in the silicone formulation.

The silicone formulation may include a conventional, commercially prepared silicone formulation. The commercially prepared silicone formulation typically includes components such as the non-polar silicone polymer, the catalyst, a filler, and optional additives. Any reasonable filler and additives are envisioned. Particular embodiments of a commercially available liquid silicone rubber (LSR) include Wacker Elastosil® LR 3003/50 by Wacker Silicone of Adrian, Mich. and Rhodia Silbione® LSR 4340 by Rhodia Silicones of Ventura, Calif.

Further, the components of the second polymer may be processed by any method envisioned. For instance, processing may include heating any combination of the components of the second polymer to any temperature envisioned so that it has a desirable viscosity for delivery such that the second polymer may flow into the mold 104. Although illustrated as one port 116 for the second polymer, any number of ports are envisioned which can deliver at least one polymer into the mold 104.

In an embodiment, the mold 104 may be configured to deliver the first polymer material prior to providing the second polymer material. In an alternative embodiment, the mold 104 may be configured to provide the second polymer material prior to providing the first polymer material. In a particular embodiment, the first polymer material is provided, the first polymer material having a surface. In an exemplary embodiment, the surface of the first polymer material is treated with at least the radiation energy prior to providing the second polymer material to provide enhanced bonding of the second polymer material to the first polymer material. In an embodiment, the surface of the first polymer material is treated prior to being placed in the mold, in situ in the mold, or combination thereof. In an embodiment, the second polymer material and the first polymer material are treated with at least the radiation source when the second polymer material and the first polymer material are in direct contact. For instance, the radiation treatment of the first polymer material when in direct contact with the silicone formulation provides an in situ treatment within the mold for increased adhesion between the first polymer material and the silicone formulation without any pre-treatment of a surface of the silicone formulation, a surface of the first polymer material, or combination thereof. In a particular embodiment, the radiation treatment provides an enhanced bonding of the first polymer material to the silicone formulation.

When thermal treatment is used in conjunction with the radiation source, it may enhance the adhesion reaction rate between the first polymer and the silicone formulation. For instance, a combination of the radiation energy and the thermal treatment provides an adhesion reaction rate of the silicone formulation to a first polymer material, wherein the adhesion reaction rate is 20% faster compared to a cure with a single source of energy. In an exemplary embodiment, thermal treatment used in conjunction with the radiation source may provide increased adhesion between the first polymer material and the silicone formulation. In particular, increased adhesion may occur with thermal treatment at a low temperature. Exemplary thermal treatment includes temperatures, for instance, of greater than about 20° C., such as greater than about 100° C., or even greater than about 150° C. In a particular embodiment, the temperature is about 20° C. to about 200° C., such as about 20° C. to about 150° C., such as about 20° C. to about 100° C., or even about 40° C. to about 80° C. In a more particular embodiment, a cohesive bond is achieved between the first polymer material and the second polymer material, i.e. cohesive failure occurs wherein the structural integrity of the first polymer material and/or the second polymer material fails before the bond between the two materials fails.

The apparatus can also include a control system 120 that includes one or more computing devices. The control system 120 can provide signals to one or more of the components of the apparatus 100 to specify operating conditions for the components. For example, the control system 120 can adjust a speed of the pumping system 102, 118. For instance, the control system 120 can adjust the level of radiation of the radiation source 110, the level of thermal treatment from a source of heat 114, or combination thereof. Further, the control system 120 can adjust any conditions envisioned.

In certain instances, the signals provided by the control system 120 can be based, at least partly, on feedback information provided by one or more sensors (not shown) of the apparatus 100. Any reasonable sensor is envisioned. In some embodiments, the one or more sensors can be part of a component of the apparatus 100, such as a pressure sensor of the pumping system 102 for the first polymer material, a sensor of the inner cavity 108, a sensor of the components providing the radiation source 110, a sensor of the heat source 114, a sensor for the port 116 and/or pumping system 118 for the second polymer, or any combination thereof.

The apparatus 100 can operate to form any reasonable injection molded article. For instance, any injection molded article may be envisioned. In a particular embodiment, the injection molded article is a 2-dimensional article where the thickness is significantly smaller than the other two dimensions or a 3-dimentional article where the thickness is comparable to the other two dimensions of either open or closed geometry, and the like. An exemplary article includes, but is not limited to, a gasket, a seal, a diaphragm, an o-ring, and other items. The injection molded article may include any number of layers, any number of protrusions, or combination thereof. Further, the injection molded article may include any number of thermoplastic polymers, thermoset polymers, or combination thereof in conjunction with the silicone formulation.

In a particular embodiment, the apparatus 100 can form injection molded articles that are not achieved by conventional injection molding manufacturing processes. In particular, the radiation source 110 of the apparatus 100 and the configuration of the apparatus 100 are conducive to forming injection molded articles with at least one polymeric material, or even at least two polymeric materials that conventional injection molded systems are not able to produce. For instance, the apparatus 100 and the processing conditions can provide a cured article of a silicone material in direct contact with a first polymer material. In an embodiment, the radiation source 110 surface treats the first polymer material to provide an injection molded article having desirable adhesion to the second polymer material. In a particular embodiment, the radiation source 110 cures the second polymer material to provide an injection molded article with desirable and in some cases, improved properties compared to an injection molded article cured by conventional heat cure. “Conventional heat cure” as used herein refers to curing via heat at a temperature greater than about 150° C.

Although a typical apparatus and process is described, any variations may be envisioned that delivers the at least one polymer material to the mold and provides an energy source to the at least one polymer material. For example, the apparatus can include any additional features such as a gear pump, a static mixer, a post-processing device, or any combination thereof.

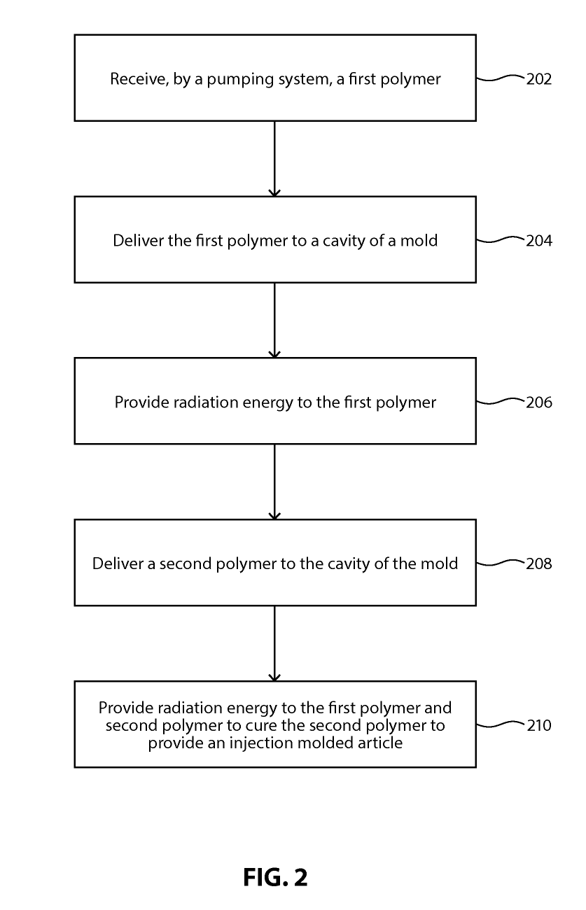

FIG. 2 is a flow diagram of a method 200 to make an injection molded article according to an embodiment. At 202, the process 200 includes receiving, by a pumping system, the first polymer material as described above. The pumping system can include any number of devices envisioned that can be utilized to form the injection molded article.

At 204, the process 200 includes delivering the first polymer material to a cavity of a mold. Typically, the first polymer material is mixed before being provided to the cavity. Any reasonable mixing apparatus is envisioned. In an embodiment, the first polymer material may be temperature controlled within the pumping system. Temperature control may include heating, cooling, or any combination thereof. For instance, any reasonable temperature control for the components of the first polymer may be used to provide a material that can flow from the pumping system and to the interior cavity of the mold without degradation of the first polymer material. The temperature is typically dependent upon on the material chosen for the first polymer material.

In an embodiment, the process 200 includes providing radiation energy to the first polymer material at 206. Any reasonable radiation source is envisioned such as actinic radiation. In an embodiment, the radiation source is ultraviolet light (UV). In a particular embodiment, the radiation can occur while the first polymer material is within the interior cavity of the mold. In a more particular embodiment, the radiation can provide a surface treatment to the surface of the first polymer material. Further, thermal treatment may be applied. In an embodiment, the first polymer may be subjected to the radiation source and the thermal treatment in sequence, concurrently, or any combination thereof.

At 208, a second polymer, such as the silicone formulation, may be delivered to the cavity, such as via a pumping system. Typically, the second polymer material is mixed before being provided to the cavity. Any reasonable mixing apparatus is envisioned. In an embodiment, heat may also be applied to the silicone formulation within the pumping system. For instance, any reasonable heating temperature for the components of the silicone formulation may be used to provide a material that can flow from the pumping system and to the interior cavity of the mold without degradation of the second polymer material. For instance, the temperature may be about 50° F. to about 150° F.

Any reasonable processing operations are envisioned once the second polymer is provided to the interior cavity of the mold. For instance, at 210 the first and second polymers may be subjected to a radiation source. Any reasonable radiation source is envisioned such as actinic radiation. In an embodiment, the radiation source is ultraviolet light (UV). In a particular embodiment, the radiation curing can occur while the second polymer material is within the interior cavity of the mold to form the injection molded article. In an embodiment, the first and second polymers may be subjected to a heat treatment. In a particular embodiment, the heat treatment is at a low temperature. In an embodiment, the first and second polymers may be subjected to the radiation source and the heat treatment in sequence, concurrently, or any combination thereof.

Any order of delivery of the first polymer material, delivery of the second polymer material, radiation source, heat treatment, or combination thereof is envisioned. Although the second polymer is described in this embodiment as being delivered after the first polymer material is delivered to the interior cavity, the second polymer may be delivered prior to delivery of the first polymer material or concurrently with the first polymer material. In a particular example, the first polymer is delivered to the interior cavity of the mold prior to the delivery of the silicone formulation. In an example and prior to delivery of the silicone formulation to the interior cavity of the mold, the first polymer material is subjected to an in situ radiation source, a heat treatment, or combination thereof. The radiation source, the heat treatment, or combination thereof can provide a surface of the first polymer that has increased adhesion to the silicone formulation when the silicone formulation is delivered to the interior cavity of the mold. After delivery of the silicone formulation to the interior cavity of the mold, the silicone formulation may be subjected to an in situ radiation source, a heat treatment, or combination thereof to substantially cure the silicone formulation and form the injection molded article. In an embodiment, the radiation source, the heat treatment, or combination thereof does not occur until after the first polymer material and the silicone formulation are delivered to the interior cavity of the mold and the silicone formulation is in direct contact with the first polymer material to provide improved adhesion between the silicone formulation and the first polymer material as well as substantially cure the silicone formulation to form the injection molded article.

Once formed and cured, particular embodiments of the above-disclosed apparatus advantageously exhibit desired properties such as increased productivity and an improved injection molded article. For example, the final properties of the injection molded article can be designed during in-line production. Furthermore, the cure of the injection molded article provides a final product with increased adhesion of the first polymer material to the silicone formulation, compared to an injection molded article that is conventionally molded and heat cured. Although not being bound by theory, it is believed that the radiation provides instant penetration of the radiation into the at least one polymer, or combination thereof and curing of the at least one polymer concurrently. In an exemplary embodiment, it is believed that the radiation provides instant penetration of the radiation into the second polymer, or combination thereof and curing of the second polymer concurrently. Furthermore, the radiation curing, with or without thermal curing, provides a faster cure compared to conventional thermal cure. The faster cure of the radiation curing, with or without thermal curing, further provides an increased adhesion of the silicone formulation with the first polymer material since it is believed that the increased adhesion reaction rate has a rate comparable to a cross-linking reaction, thus with an increased bonding formation between the silicone formulation and the first polymer material. For instance, the first polymer and the silicone formulation of the injection molded article have a peel strength that exhibits cohesive failure. “Cohesive failure” as used herein indicates that the cured silicone formulation or the first polymer ruptures before the bond between the cured silicone formulation and the first polymer fails, when tested in a parallel Peel configuration at room temperature as described in the Examples. In particular, desirable adhesion may be achieved without a primer, a chemical surface treatment, a mechanical surface treatment, or any combination thereof.

The injection molded article further provides physical-mechanical properties such as desirable loss modulus, tensile modulus, compression set, and the like. For instance, the injection molded article has desirable loss modulus, tensile modulus, and compression set compared to a conventionally produced injection molded article, such as an injection molded article that has been cured solely by thermal treatment.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Items

Item 1. An apparatus for forming an injection molded article, including a pumping system to deliver a silicone formulation to a mold, the silicone formulation having a viscosity of about 50,000 centipoise to about 2,000,000 centipoise; the mold having an exterior housing and an interior cavity therein, wherein the silicone formulation flows into the cavity of the mold; and a source of radiation energy, wherein the radiation energy substantially cures the silicone formulation within the cavity of the mold to form the injection molded article.

Item 2. A method of forming an injection molded article, including providing a silicone formulation within a pumping system, wherein the silicone formulation has a viscosity of about 50,000 centipoise to about 2,000,000 centipoise; providing a mold having an exterior housing and an interior cavity therein; delivering the silicone formulation from the pumping system to the cavity of the mold; and irradiating the silicone formulation with a radiation source to substantially cure the silicone formulation within the cavity of the mold to form the injection molded article.

Item 3. A mold for an injection molded article including an exterior housing and an interior cavity therein, wherein the interior cavity is configured for receipt of a silicone formulation having a viscosity of about 50,000 centipoise to about 2,000,000 centipoise; and a source of radiation energy, wherein the radiation energy substantially cures the silicone formulation within the cavity of the mold to form the silicone article.

Item 4. The apparatus, the method of forming the injection molded article, and the mold of any of the preceding Items, wherein the source of radiation energy is disposed between the housing and the cavity.

Item 5. The apparatus, the method of forming the injection molded article, and the mold of any of the preceding Items, wherein the radiation source is ultraviolet light with wavelength between 10 and 410 nm.

Item 6. The apparatus, the method of forming the injection molded article, and the mold of any of the preceding Items, wherein at least a portion of the cavity is substantially transparent to the radiation source.

Item 7. The apparatus, the method of forming the injection molded article, and the mold of Item 6, wherein the at least portion of the cavity that is substantially transparent is a quartz, a glass, a sapphire, a polymer, or combination thereof.

Item 8. The apparatus, the method of forming the injection molded article, and the mold of any of the preceding Items, wherein the housing of the mold further includes a source of heat for thermal treatment within the cavity of the mold.

Item 9. The apparatus, the method of forming the injection molded article, and the mold of Item 8, wherein the thermal treatment is at a temperature of about 20° to about 200° C., such as about 20° C. to about 150° C., such as about 20° C. to about 100° C., or even about 40° C. to about 80° C.

Item 10. The apparatus, the method of forming the injection molded article, and the mold of Item 9, wherein the application of the radiation energy and the thermal treatment provide an increased adhesion compared to a cure with a single source of energy.

Item 11. The apparatus, the method of forming the injection molded article, and the mold of Item 8, wherein the source of heat includes an electric resistive heating element, an externally heated thermal fluid pumped through at least one channel in the mold, or combination thereof.

Item 12. The apparatus, the method of forming the injection molded article, and the mold of Item 8, wherein the radiation energy and the thermal treatment are applied to the silicone formulation in sequence, concurrently, or combination thereof.

Item 13. The apparatus, the method of forming the injection molded article, and the mold of Item 8, wherein the application of the radiation energy and the thermal treatment provide a cure time that is 20% faster compared to a cure with a single source of energy.

Item 14. The apparatus, the method of forming the injection molded article, and the mold of Item 8, wherein the application of the radiation energy and the thermal treatment provides an adhesion reaction rate of the silicone formulation to a thermoplastic polymer or a thermoset polymer, wherein the adhesion reaction rate is 20% faster compared to a cure with a single source of energy.

Item 15. The apparatus, the method of forming the injection molded article, and the mold of any of the preceding Items, wherein the mold further includes a port to the cavity to provide a thermoplastic polymer or a thermoset polymer to the cavity.

Item 16. The apparatus, the method of forming the injection molded article, and the mold of Item 15, wherein the thermoplastic polymer or thermoset polymer is polycarbonate, polystyrene, acrylonitrile butadiene styrene, polyester, silicone, copolyester, a fluoropolymer, polyethylene, polypropylene, or combination thereof.

Item 17. The apparatus, the method of forming the injection molded article, and the mold of Item 15, wherein the silicone formulation is provided to the cavity prior to providing the thermoplastic polymer or the thermoset polymer.

Item 18. The apparatus, the method of forming the injection molded article, and the mold of Item 15, wherein the thermoplastic polymer or the thermoset polymer is provided to the cavity prior to providing the silicone formulation.

Item 19. The apparatus, the method of forming the injection molded article, and the mold of Item 18, wherein a surface of the thermoplastic polymer or the thermoset polymer is treated with at least radiation energy prior to providing the silicone formulation, wherein the treated surface of the thermoplastic polymer or the thermoset polymer has enhanced bonding to the silicone formulation.

Item 20. The apparatus, the method of forming the injection molded article, and the mold of Items 17 or 18, wherein the thermoplastic polymer or the thermoset polymer and the silicone formulation are directly in contact and treated with at least radiation energy

Item 21. The apparatus, the method of forming the injection molded article, and the mold of any of the Items 19 or 20, wherein the thermoplastic polymer or the thermoset polymer and the silicone formulation have a peel strength having cohesive failure.

Item 22. The apparatus, the method of forming the injection molded article, and the mold of any of the preceding Items, wherein the silicone formulation is a liquid silicone rubber (LSR), a room temperature vulcanizable silicone (RTV), or combination thereof.

Item 23. The apparatus, the method of forming the injection molded article, and the mold of any of the preceding Items, wherein the silicone formulation further includes an adhesion promoter.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1

An LSR formulation is prepared using 96.5 weight % (wt %) of a vinyl containing silicone base (custom made at a Toll Manufacturer, vinyl content at 0.04 mmol/g and filler content at about 25% by wt. of the vinyl containing silicone base), 0.95 wt % of a blend of two hydride crosslinkers (such as Andersil XL-10 and Gelest HMS-993), 1.65 wt % master batch of UV activatable catalyst such as (Trimethyl)methylcyclopentadienyl platinum (IV), equivalent to about 16.5 ppm of the catalyst, and 0.9 wt % of a silane type adhesion promoter. The compounding is done in a high shear mixer like Ross mixer, following typical compounding procedures. Viscosity of the silicone formulation is about 300,000 centipoise to about 500,000 centipoise.

The LSR formulation is tested for adhesive strength with several thermoplastic materials such as a fluoropolymer, polystyrene, acrylonitrile butadiene styrene (ABS), polypropylene, polycarbonate and polyester. The LSR formulation is molded on a thermoplastic substrate with the LSR formulation as the top layer at a thickness of 2.0 mm for each layer with a 1 inch by 1 inch overlap of the two layers. Cure conditions is ultraviolet cure and thermal treatment at about 80° C. to about 100° C. Peel strength is tested using an Instron extensometer pull test, with a parallel pull of the two layers in opposite directions. The test has a head speed of two inches per minute until the sample fails. The maximum load is measured as well as the failure mode: adhesive (failure at an interface between the two layers) or cohesive (failure within the silicone material). A copolyester (Tritan™, available from Eastman Chemical Company) and a silane primed polytetrafluoroethylene (PTFE) fluoropolymer both have excellent bonding to the LSR formulation, exhibiting cohesive failure with a maximum loading of greater than 30 lbf (pound force). Both ABS and polycarbonate have good bonding that is semi-cohesive with a maximum load of greater than 10 lbf. Polystyrene has marginal bonding but with ultraviolet pre-treatment and heating, the adhesion to the LSR formulation improves.

### Example 2

An LSR formulation is prepared using 96.5 wt % of a vinyl containing silicone base (custom made at a Toll Manufacturer, vinyl content at 0.04 mmol/g and filler content at about 25% by wt. of the vinyl containing silicone base), 1.1 wt % of a blend of two hydride crosslinkers (such as Andersil XL-10 and Gelest HMS-993), 1.5 wt % master batch of UV activatable catalyst such as (Trimethyl)methylcyclopentadienyl platinum (IV), equivalent to about 16.5 ppm of the catalyst, and 0.9 wt % of a silane type adhesion promoter (different from above Example 1). The compounding is done in a high shear mixer like Ross mixer, following typical compounding procedures. Viscosity of the formulation is about 300,000 centipoise to about 500,000 centipoise.

The LSR formulation is tested for adhesive strength with several thermoplastic materials such as polystyrene, ABS, polypropylene, polycarbonate and polyester. Peel strength is tested using an Instron extensometer pull test as described for Example 1. A copolyester (Tritan™, available from Eastman Chemical Company) and a silane primed polytetrafluoroethylene (PTFE) fluoropolymer both have excellent bonding to the LSR formulation, exhibiting cohesive failure with a maximum loading of greater than 30 lbf (pound force). Both ABS and polycarbonate have good bonding that is semi-cohesive with a maximum load of greater than 10 lbf. Polystyrene has marginal bonding but with ultraviolet pre-treatment and heating, the adhesion to the LSR formulation improves.

### Example 3

An LSR formulation similar to Example 1 is prepared. The formulation is tested for adhesive strength with several thermoplastic material substrates such as coPolyester (Tritan™, available from Eastman Chemical Company) with UV surface treatment achieved with a Newport Solar Simulator Model 92190-1000. Results can be seen in Table 1 of a UV surface treatment of the thermoplastic material.

Cure conditions is ultraviolet cure and thermal treatment at about 80° C. to about 100° C. Peel strength is tested using an Instron extensometer pull test as described for Example 1.

TABLE 1

| Surface | | Maximum | | |
|---|---|---|---|---|
| treatment | Sample | load (lb-f) | PPI | |
| 5 Min @ 80° C. UV | 1 | 35.48 | 419.12 | |
| Treated Tritan 731 | | | | |
| 5 Min @ 80° C. UV | 2 | 34.5 | 407.55 | |
| Treated Tritan 731 | | | | |
| 5 Min @ 80° C. UV | 3 | 32.71 | 386.41 | |
| Treated Tritan 711 | | | | |
| 5 Min @ 80° C. UV | 4 | 31.79 | 375.56 | |
| Treated Tritan 711 | | | | |
| 3 Min @ 80° C. UV | 5 | 40.27 | 475.79 | |
| Treated Tritan 731 | | | | |
| 2 Min @ 80 C. UV | 6 | 46.38 | 547.92 | (COF) |
| Treated Tritan 731 | | | | |
| 2 Min @ 80° C. UV | 7 | 43.82 | 517.68 | (COF) |
| Treated Tritan 711 | | | | |
| 2 Min @ 80° C. UV | 8 | 45.03 | 532.01 | (COF) |
| Treated Tritan 711 | | | | |
| 2 Min @ 80° C. UV- | 9 | 43.16 | 509.9 | (COF) |
| UN Treated Tritan 731 | | | | |
| 2 Min @ 80° C. UV- | 10 | 43.53 | 514.3 | (COF) |
| UN Treated Tritan 731 | | | | |
| 2 Min @ 80° C. UV- | 11 | 39.33 | 464.66 | (COF) |
| UN Treated Tritan 711 | | | | |
| 2 Min @ 80° C. UV- | 12 | 46.12 | 544.84 | COF) |
| UN Treated Tritan 711 | | | | |

Successful peel strength is achieved with the surface treated and untreated coPolyester samples when exposed to UV cure. Although not being bound by theory, the level of in situ UV cure and thermal treatment may provide advantageous peel strength without surface treatment of the coPolyester.

Table 2 is further samples on different thermoplastic material substrates. The surface of the thermoplastic material is UV treated with a Newport Solar Simulator Model 92190-1000 at a temperature of 80° C. (176° F.) at for 2 minutes. Sample sizes are 1 inch by 2 inch.

Cure conditions is ultraviolet cure and thermal treatment at about 80° C. to about 100° C. Peel strength is tested using an Instron extensometer pull test as described for Example 1.

TABLE 2

| | Maximum | Peel strength |
|---|---|---|
| Sample | load (lb-f) | (Newton) |
| Unprimed Skived PTFE-10 mil | 5.732 | 25.50 |
| Primed Natural Skived PTFE-10 mil | COF | COF |
| Primed Red Cast PTFE-3 mil | 4.271 | 19.00 |

Clearly, successful bonding is achieved with polytetrafluoroethylene (PTFE).

### Example 4

Two LSR formulations similar to Example 1 are prepared. The formulations are tested for adhesive strength with several thermoplastic material substrates or thermoset material substrates such as coPolyester (Tritan™, available from Eastman Chemical Company), polypropylene, polycarbonate, polyester, a silicone, such as a high consistency rubber (HCR). The surface of the thermoplastic materials are UV treated with a 300 W UV LED bulb at a temperature of 80° C. (176° F.) at 65 Volts/5+A for 2 minutes. Comparisons can be seen in Table 3 of a UV surface treatment of the thermoplastic material or thermoset material versus untreated surfaces.

Cure conditions is ultraviolet cure and thermal treatment at about 80° C. to about 100° C. Peel strength is tested using an Instron extensometer pull test as described for Example 1.

TABLE 3

| Treated/ | Substrate | Sample A | Sample B |
|---|---|---|---|
| Untreated | material | Adhesion | Adhesion |
| UV treated | Tritan ™ 711 | Yes | Yes |
| Un treated | Tritan ™ 711 | No | No |
| UV treated | Tritan ™ 731 | Yes | Yes |
| Un treated | Tritan ™ 731 | No | No |
| UV treated | Polycarbonate | Yes | Yes |
| Un treated | Polycarbonate | Not tested | No |
| Un treated | Silicone HCR | Yes | Yes |

Successful adhesion is achieved with all UV surface treated samples as well as the untreated silicone HCR sample. Although not to be bound by theory, it is theorized that the UV LED provides a weaker source of energy than the source of UV surface treatment in the previous Examples.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An apparatus for forming an injection molded article, comprising:
a pumping system to deliver a silicone formulation to a mold, the silicone formulation having a viscosity of about 50,000 centipoise to about 2,000,000 centipoise;
the mold having an exterior housing and an interior cavity therein, wherein the silicone formulation flows into the cavity of the mold; and
a source of radiation energy, wherein the radiation energy substantially cures the silicone formulation within the cavity of the mold to form the injection molded article.

2. A method of forming an injection molded article, comprising:
providing a silicone formulation within a pumping system, wherein the silicone formulation has a viscosity of about 50,000 centipoise to about 2,000,000 centipoise;
providing a mold having an exterior housing and an interior cavity therein;
delivering the silicone formulation from the pumping system to the cavity of the mold; and
irradiating the silicone formulation with a radiation source to substantially cure the silicone formulation within the cavity of the mold to form the injection molded article.

3. A mold for an injection molded article comprising:
an exterior housing and an interior cavity therein, wherein the interior cavity is configured for receipt of a silicone formulation having a viscosity of about 50,000 centipoise to about 2,000,000 centipoise; and
a source of radiation energy, wherein the radiation energy substantially cures the silicone formulation within the cavity of the mold to form the silicone article.

4. The apparatus of claim 1, wherein the source of radiation energy is disposed between the housing and the cavity.

5. The apparatus of claim 1, wherein at least a portion of the cavity is substantially transparent to the radiation source.

6. The apparatus of claim 1, wherein the housing of the mold further comprises a source of heat for thermal treatment within the cavity of the mold.

7. The apparatus of claim 6, wherein the thermal treatment is at a temperature of about 20° to about 200° C., such as about 20° C. to about 150° C., such as about 20° C. to about 100° C., or even about 40° C. to about 80° C.

8. The apparatus of claim 6, wherein the application of the radiation energy and the thermal treatment provide an increased adhesion compared to a cure with a single source of energy.

9. The apparatus of claim 6, wherein the radiation energy and the thermal treatment are applied to the silicone formulation in sequence, concurrently, or combination thereof.

10. The apparatus of claim 1, wherein the mold further comprises a port to the cavity to provide a thermoplastic polymer or a thermoset polymer to the cavity.

11. The apparatus of claim 10, wherein the thermoplastic polymer or thermoset polymer is polycarbonate, polystyrene, acrylonitrile butadiene styrene, polyester, silicone, copolyester, a fluoropolymer, polyethylene, polypropylene, or combination thereof.

12. The apparatus of claim 10, wherein the thermoplastic polymer or the thermoset polymer is provided to the cavity prior to providing the silicone formulation.

13. The apparatus of claim 12, wherein a surface of the thermoplastic polymer or the thermoset polymer is treated with at least radiation energy prior to providing the silicone formulation, wherein the treated surface of the thermoplastic polymer or the thermoset polymer has enhanced bonding to the silicone formulation.

14. The apparatus of claim 12, wherein the thermoplastic polymer or the thermoset polymer and the silicone formulation are directly in contact and treated with at least radiation energy

15. The apparatus of claim 1, wherein the silicone formulation is a liquid silicone rubber (LSR), a room temperature vulcanizable silicone (RTV), or combination thereof.

16. The apparatus of claim 1, wherein the silicone formulation further comprises an adhesion promoter.

17. The method of claim 2, wherein the housing of the mold further comprises a source of heat for a thermal treatment within the cavity of the mold to provide the thermal treatment at a temperature of about 20° to about 200° C., such as about 20° C. to about 150° C., such as about 20° C. to about 100° C., or even about 40° C. to about 80° C.

18. The method of claim 2, wherein the mold further comprises a port to the cavity to provide a thermoplastic polymer or a thermoset polymer to the cavity.

19. The method of claim 18, wherein the thermoplastic polymer or the thermoset polymer is provided to the cavity prior to providing the silicone formulation.

20. The method of claim 19, wherein a surface of the thermoplastic polymer or the thermoset polymer is treated with at least radiation energy prior to providing the silicone formulation, wherein the treated surface of the thermoplastic polymer or the thermoset polymer has enhanced bonding to the silicone formulation.
